(19) United States
(12) Patent Application Publication
(10) Pub. No.: US 2018/0328737 A1
(43) Pub. Date: Nov. 15, 2018

(54) Method And Arrangement For Calculating Navigation Paths For Objects In Buildings Or On A Campus

(71) Applicant: Siemens Schweiz AG, Zuerich (CH)

(72) Inventors: Christian Frey, Unteraegeri (CH); Oliver Zechlin, Zug (CH)

(73) Assignee: Siemens Schweiz AG, Zuerich (CH)

(21) Appl. No.: 15/976,573

(22) Filed: May 10, 2018

(30) Foreign Application Priority Data
May 15, 2017 (DE) 10 2017 208 174.0

(51) Int. Cl. G01C 21/20; G01C 21/34; G01C 21/36

(52) U.S. Cl. CPC G01C 21/20; G01C 21/206; H04W 84/12; G01C 21/3667; G01C 21/3423

(57) ABSTRACT

An example arrangement for calculating navigation paths for objects in a building may include: a transmitter for position signals; a mobile communications terminal associated with the object receiving the signals, then transmitting the position signals to a server; and a storage unit storing a building information model. The server receives the signals from the terminal, then, based on the received signals and building data, generates a navigation path for the object from a start point to a destination.

### CROSS-REFERENCE TO RELATED APPLICATIONS

This application claims priority to DE Application No. 10 2017 208 174.0 filed May 15, 2017, the contents of which are hereby incorporated by reference in their entirety.

### TECHNICAL FIELD

The present disclosure relates to navigation. Various embodiments may include methods and arrangements for calculating navigation paths for objects in buildings or on a campus.

### BACKGROUND

Systems and methods for positioning and for navigation in buildings (known as Indoor Positioning Systems, IPS) without the use of GPS signals may include evaluation of radio signals from WLAN access points (Wireless Access Points) or the evaluation of iBeacon signals. iBeacons (from Apple) are an established proprietary standard for navigation in closed spaces using Bluetooth Low Energy (BLE). The method can be used by current iPhone and Android devices.

BLE beacon functions, such as indoor navigation, are based on a transmitter-receiver principle. For this, small transmitters (beacons) are placed in the space as signal generators, and these emit signals at fixed time intervals. If a receiver, for example a smartphone with an installed mobile app configured to receive BLE beacon signals, is identified in the range of a transmitter, the UUID (Universally Unique Identifier) of the transmitter can be identified and its signal strength measured. If at least three beacons are in the range of the receiver, the position of the receiver in the two-dimensional space can be calculated for example by trilateration or the fingerprinting method. Four beacons are required in range for determining a location in a three-dimensional space.

However, for navigation solutions based on Indoor Positioning Systems, it is necessary to make adjustments in the physical environment, especially inside buildings, or in the case of campus-like complexes between buildings. Therefore, for example, possible routes must be manually defined in the building or on the campus. Some examples include applying what are known as navigation graphs or route lines. If these adjustments are not made, incorrect calculations, loss of user confidence, and ultimately non-use of the navigation solution result because a calculated route from A to B, which leads across desks and through walls, is unsatisfactory for an operator or user.

Unlike in the case of navigation solutions for traffic, Indoor Positioning Systems will not compensate a possible positional inaccuracy by way of logic. In the case of navigation systems for traffic it is assumed that, for example, a journey occurs on the motorway at 130 km/h instead of in the woods next to the motorway even if the position determined by received satellite signals states the vehicle is in the woods. People in buildings are not tied to strict traffic or route management.

Furthermore, Indoor Positioning Systems based on radio waves (BLE, WLAN) only provide a level of accuracy of several meters. The indicated position of a person in an office could therefore be in a corridor, in an adjoining space or even outside building. Unlike in the example of vehicle navigation, there are few to no logical exclusion criteria in the case of people navigation.

### SUMMARY

The teachings of the present disclosure may provide methods and arrangements which increase the accuracy of routing of navigation systems, based on Indoor Positioning Systems. For example, an arrangement for calculating navigation paths (NP) for objects (P, P1) in buildings (B) or on a campus may include: a transmitting device (SV1-SV10) for transmitting position signals (PS1-PS6); a mobile communications terminal (MG, MG1), associated with the object (P, P1), adapted to receive the position signals (PS1-PS6) and to transmit the position signals to a server (S); a server (S); and a storage unit (SP), with which the server (S) has a data link, wherein a building information model (BIM) of the building (B) is stored in the storage unit (SP). In some embodiments, the server (S) is adapted to receive the position signals (PS1-PS6) transmitted by the mobile communications terminal (MG, MG1). In some embodiments, the server (S) is adapted, based on the respective received position signals (PS1-PS6) and based on building data stored in the building information model (BIM), to generate a navigation path (NP) for a respective object (P, P1) from a defined start point (SPT) to a defined destination (ZPT), wherein start point (SPT) and destination (ZPT) can be defined by a user input at the mobile communications terminal (MG, MG1).

Some embodiments may include an arrangement for calculating navigation paths (NP) for objects (P, P1, P2) in buildings (B) or on a campus comprising: a transmitting device (SV1-SV10) for transmitting position signals (PS1-PS6); and a first mobile communications terminal (MG1), associated with the object (P1), adapted to receive the position signals (PS1-PS6) and to transmit the position signals (PS1-PS6) to a second mobile communications terminal (MG2), the latter having a data link to a storage unit (SP), wherein a building information model (BIM) of the building (B) is stored in the storage unit (SP). In some embodiments, the second mobile communications terminal (MG2) is adapted, based on the respective received position signals (PS1-PS6) and based on building data stored in the building information model (BIM), to generate a navigation path (NP) for a respective object (P1) from a defined start point (SPT) to a defined destination (ZPT), wherein start point (SPT) and destination (ZPT) can be defined by a user input at the first mobile communications terminal (MG1).

In some embodiments, the building data stored in the building information model (BIM) includes semantic information and/or metainformation.

In some embodiments, the transmitting device (SV1-SV10) is designed as an Indoor Positioning System (IPS).

In some embodiments, the server (S) is integrated in a building control center (BMS), in particular in a central fire alarm system.

In some embodiments, the mobile communications terminal (MG, MG1, MG2) is adapted to calibrate the position of the object (P, P1) on the basis of the received position signals (PS1-PS6).

In some embodiments, the position of the object (P, P1) can be calibrated such that the inaccuracy of the positioning is compensated from the received position signals (PS1-PS6), such that the object can only be located on a position graph or navigation path (NP).

In some embodiments, a minimum spacing from the navigation path (NP) can be defined on the basis of the metadata of a stationary object.

In some embodiments, the metadata comprises a defined minimum spacing from the calculated navigation path (NP).

In some embodiments, during an emergency evacuation, the navigation path (NP) can be calculated on the basis of an escape route optimization and/or a pedestrian flow simulation.

In some embodiments, the mobile communications terminal (MG, MG1, MG2) is adapted to depict the calculated navigation path (NP) on the display of the mobile communications terminal (MG, MG1).

In some embodiments, the building data stored in the building information model (BIM) also includes metadata of mobile building objects, in particular driverless transport systems, mobile robots, or cleaning robots, wherein this metadata defines a minimum spacing of the mobile building objects from the objects (P, P1) on the navigation path (NP).

As another example, some embodiments may include a method for calculating navigation paths for objects (P, P1) in buildings (B) or on a campus comprising: (VS1) determining the position data (PS1-PS6) of a communications terminal (MG, MG1) associated with the object (P, P1); (VS2) transmitting the position data (PS1-PS6) of the object (P, P1) from the communications terminal (MG, MG1) to a server (S); and (VS3) calculating the navigation path through the server (S) for a respective object (P, P1) from a defined start point (SPT) to a defined destination (ZPT). The start point (SPT) and destination (ZPT) can be defined by a user input at mobile communications terminal (MG, MG1). The navigation path (NP) may be calculated on the basis of the respective position data (PS1-PS6) of the object (P, P1) and on the basis of building data stored in a building information model (BIM).

In some embodiments, the navigation path (NP) is displayed on a mobile communications terminal (MG, MG1) associated with the object (P, P1).

In some embodiments, the building data stored in the building information model (BIM) includes semantic information and/or metainformation.

In some embodiments, the position of the object (P, P1) is calibrated such that the inaccuracy of the positioning is compensated from the received position signals (PS1-PS6) such that the object (P, P1) can essentially or only be located on a position graph or navigation path (NP).

### BRIEF DESCRIPTION OF THE DRAWINGS

The teachings herein and various embodiments thereof are illustrated using the example of the figures below, in which:

FIG. 1 shows a first exemplary arrangement for calculating navigation paths for objects in buildings or on a campus,

FIG. 2 shows a second exemplary arrangement for calculating navigation paths for objects in buildings or on a campus,

FIG. 3 shows an exemplary flowchart for calculating navigation paths for objects in buildings or on a campus, and

FIG. 4 shows an exemplary navigation path in an office building.

### DETAILED DESCRIPTION

In some embodiments, an arrangement for calculating navigation paths for objects in buildings or on a campus includes: a transmitting device for transmitting position signals; a mobile communications terminal, associated with the object, adapted to receive the position signals and to transmit the position signals to a server; a server; and a storage unit, with which the server has a data link, wherein a building information model (BIM) of the building is stored in the storage unit. In some embodiments, the server is adapted to receive the position signals transmitted by the mobile communications terminal. In some embodiments, the server is adapted, based on the respective received position signals and based on building data stored in the building information model (BIM), to generate a navigation path for a respective object from a defined start point to a defined destination, wherein start point and destination can be defined by a user input at the mobile communications terminal.

In some embodiments, an arrangement for calculating navigation paths for objects in buildings or on a campus includes: a transmitting device for transmitting position signals; and a first mobile communications terminal, associated with the object, adapted to receive the position signals and to transmit the position signals to a second mobile communications terminal, the latter having a data link to a storage unit, wherein a building information model (BIM) of the building is stored in the storage unit. In some embodiments, the second mobile communications terminal is adapted, based on the respective received position signals and based on building data stored in the building information model (BIM), to generate a navigation path for a respective object from a defined start point to a defined destination, wherein start point and destination can be defined by a user input at the first mobile communications terminal.

By including building data (for example metadata of articles, furnishings or interior fittings in the building, such as dimension, material, position, etc.) stored in the building information model (BIM), a navigation algorithm can automatically create optimized and expedient route calculations for navigation paths. Metadata for a building stored in the building information model can be kept consistent and up-to-date at a central location.

The route calculations for the navigation paths can be centrally provided in a server, or decentrally over a network of mobile communications devices. The server and/or the storage unit (for example database server) may be implemented in a cloud infrastructure.

In some embodiments, the objects provided for the navigation paths can be people who carry an appropriate mobile communications terminal (for example smartphone) with them, or for example driverless transport systems in the building, or cleaning robots.

In some embodiments, the building data stored in the building information model (BIM) include semantic information and/or metainformation. What is known as a Building Information Model (BIM) is increasingly common especially in new builds. Within the context of building modeling, i.e., the creation and maintenance of a building information model, optimized planning, design, and management of buildings occur with the aid of appropriate software. Here, all relevant building data is digitally acquired, combined, linked, and analyzed. Material and articles used in the building are provided within this software solution with semantic information and metainformation. This data is then available in the standardized IFC format. The “Industry Foundation Classes” (IFC) are an open standard in the building industry for the digital description of building models (Building Information Modeling).

### Example

Furnishings incorporated in the building inventory, such as a desk, comprises features, properties, or attributes that describe or define them. These could be its furnishings, solid, wood, dimension, height adjustability, position (for example coordinates) in an office layout, etc. If software then utilizes such a database for calculating routes (Indoor Navigation) and accesses the information stored there (i.e. on the building information model), these features, properties or attributes can be parsed and analyzed by the software (for example Allplan from the Nemetschek Group or AutoCAD from Autodesk), and a corresponding dynamically generated route proposal or navigation path can be generated by taking this information into account (for example by appropriately adapted navigation software, which communicates with the programs for the building information model, or accesses the database in which the building information model is stored).

A building information model will in future no longer be used just for creating the building, but instead over the entire lifecycle through to demolition. As a result, a building formula that is always current is provided, and this is kept up-to-date by a Facility Manager or a BIM Manager. The arrangements may provide objects to be navigated in buildings or on a campus, such as people (having an appropriately adapted communications terminal, for example smartphone) or independently movable mobile objects (for example correspondingly adapted cleaning robots or driverless transport systems) to be navigated in the building or on the campus.

In some embodiments, the transmitting device comprises an Indoor Positioning System (IPS). Indoor Positioning Systems (IPS) based on WLAN or iBeacons (BLE, Bluetooth Low Energy) are common nowadays or can be easily retrofitted into existing buildings. iBeacons (from Apple) are an established proprietary standard for navigation in closed spaces based on Bluetooth Low Energy (BLE). The method can be used by current iPhone and Android devices.

Such BLE beacon functions, such as, for example indoor navigation, are based on a transmitter-receiver principle. For this, small transmitters (beacons) are placed in the space as signal generators, and they transmit signals at fixed time intervals. If a receiver, for example a smartphone with an installed mobile app which is configured to receive BLE beacon signals, comes into the range of a transmitter, the UUID (Universally Unique Identifier) of the transmitter can be identified and its signal strength measured. If at least three beacons are in the range of the receiver, the position of the receiver in the two-dimensional space can be calculated for example by trilateration or the fingerprinting method. Four beacons (as beacons) in range are required for determining a location in a three-dimensional space.

In some embodiments, the server is integrated in a building control center, in particular in a central fire alarm system. Building control centers or central fire alarm systems comprise a processor infrastructure in which the server or a database server can be easily integrated with the building information model in respect of software and hardware equipment, for example as a distributed or networked system in a cloud.

In some embodiments, the mobile communications terminal (for example smartphone, notebook, or tablet computer) is adapted to calibrate the position of the object on the basis of the received position signals. Calibration of the current position of the object comprises calibration of the depiction of the current location of the object on the planes or navigation paths shown on the display of the mobile communications terminal. Calibration can take place for example based on reference beacons which emit a unique (“calibrated”) reliable position.

In some embodiments, the position of the object can be calibrated such that the inaccuracy of positioning is compensated from the received position signals such that the object can only be located on a position graph or navigation path. Objects can be displayed for example at the location of the navigation path, which represents the shortest distance between object and navigation path. Navigation paths may be predefined for particular paths or routes (for example frequently used paths or paths to particular locations) in the system.

In some embodiments, based on the metadata of a stationary (i.e. immobile or permanently positioned static object) object (for example obstacle, table, chair, . . . ), a minimum spacing from the navigation path can be defined. This ensures that the displayed navigation path depicts a safe passage. The physical dimension of the object to be navigated is advantageously also taken into account, with humans, for example mean values (for example in respect of height, girth) for adults.

In some embodiments, the building data stored in the building information model (BIM) also includes metadata of mobile, in particular independently movable, building objects, in particular driverless transport systems, mobile robots, or cleaning robots, wherein this metadata defines a minimum spacing of the mobile building objects from the objects to be navigated on the navigation path. Consequently, collisions with objects to be navigated are avoided on the navigation path. To avoid collisions, these independently movable building objects can advantageously go backwards, stop, or go into a recess. For this, the independently movable building objects (for example driverless transport systems, mobile robots, or cleaning robots) can be fitted with appropriate communications mechanisms (for example radio link), with appropriate sensors (for example proximity sensors for identifying obstacles), with a positioning system, and with appropriate control software.

In some embodiments, based on the metadata of a mobile (i.e. mobile or non-permanently positioned movable object) object (for example cleaning robots, security robots, transport robots, . . . ), a minimum spacing from people can be defined on the navigation path. This ensures that mobile objects guarantee a safe passage for people.

The physical dimension of the mobile object may be taken into account here and temporarily limits it, for example in its mobility on the navigation path (for example evading, stopping).

In some embodiments, the metadata includes a defined minimum spacing from the calculated navigation path. This ensures that objects to be navigated are navigated on a path which a certain minimum spacing (for example 1 meter, or >1 meter) from objects in the building (for example desks in an open-plan office). This keeps the disruption to other employees to a minimum.

In some embodiments, in an emergency evacuation, the navigation path can be calculated on the basis of an escape route optimization and/or a pedestrian flow simulation. As a result, navigation paths can be provided which are dimensioned such that a large number of people can be directed as quickly as possible.

In some embodiments, the mobile communications terminal is adapted to depict the calculated navigation path on the display of the mobile communications terminal. Nowadays, mobile communications terminals (for example smartphones) are fitted with navigation or positioning software or can easily be retrofitted therewith by downloading an appropriate app. The depiction of a navigation path on the display of the mobile communications terminal makes it easier for a user to find a destination. Navigation or destination finding is advantageously assisted by appropriate acoustic signals.

In some embodiments, a method for calculating navigation paths for objects in buildings or on a campus includes: determining the position data of a communications terminal associated with the object; transmitting the position data of the object from the communications terminal to a server; and calculating the navigation path through the server for a respective object from a defined start point to a defined destination. In some embodiments, start point and destination can be defined by a user input at mobile communications terminal. In some embodiments, the navigation path is calculated on the basis of the respective position data of the object and on the basis of building data stored in a building information model (BIM). The method can be easily implemented since the hardware and software components used can be commercially obtained or even exist already anyway.

In some embodiments, the navigation path is displayed on a mobile communications terminal (for example smartphone) associated with the object. As a result, people can be navigated without additional devices.

In some embodiments, the building data stored in the building information model (BIM) includes semantic information and/or metainformation. For example, the interior fittings or the furnishings in a building are stored in the building information model (BIM). Semantic information and/or metainformation relating to the interior fittings (for example elevators, stairs) or furnishings (for example positioning, orientation, type, dimensioning) of desks, shelves, copiers, cabinets, etc. and/or the composition of the floor (for example carpet, floor tiles, wood) are advantageously also stored in the building information model. This information can be kept up-to-date in a building information model at a central location. Taking this information into account during calculation of navigation paths ensures inter alia that the navigation paths depict real or accessible routes.

In some embodiments, the position of the object (for example person with smartphone, or cleaning robot) is calibrated such that the inaccuracy of the positioning is compensated from the received position signals such that the object can essentially or only be located on a position graph. Calibration can take place for example by transmitting reliable (or calibrated) reference position signals from reference beacons.

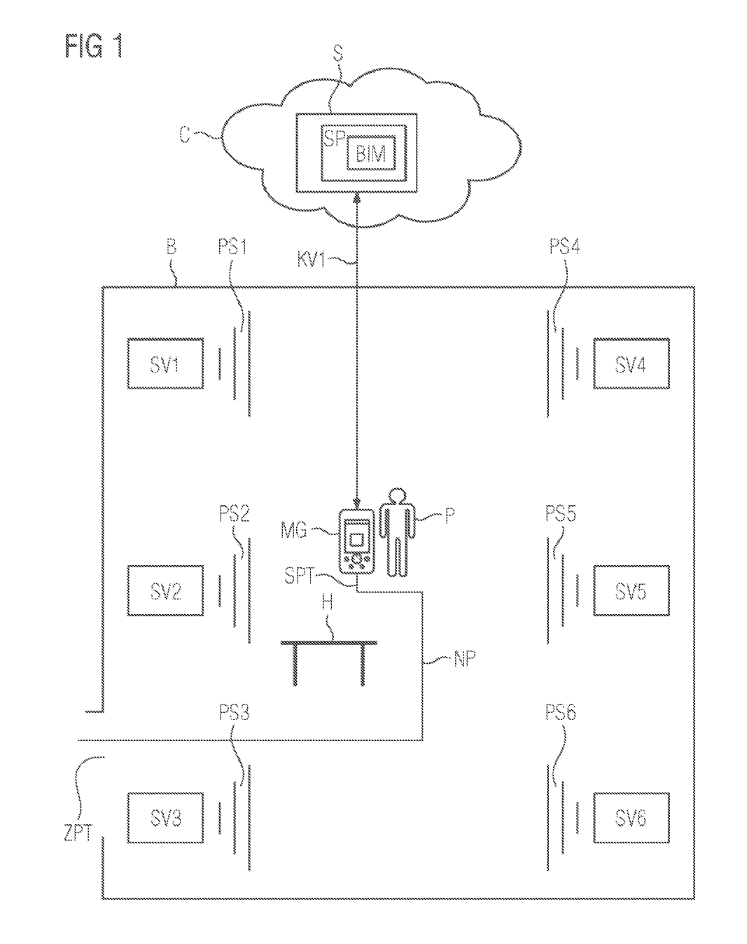

FIG. 1 shows a first exemplary arrangement for calculating navigation paths for objects P in buildings B or on a campus. The first exemplary arrangement comprises: a transmitting device SV1-SV6 for transmitting position signals PS1-PS6; a mobile communications terminal MG, associated with the object P, adapted to receive the position signals PS1-PS6 and to transmit the position signals PS1-PS6 to a server S; a server S; and a storage unit SP, with which the server S has a data link, wherein a building information model BIM of the building B is stored in the storage unit SP. The server S is adapted to receive the position signals PS1-PS6 transmitted by the mobile communications terminal MG. The server S is adapted, based on the respective received position signals PS1-PS6 and based on building data stored in the building information model BIM, to generate a navigation path NP for a respective object P from a defined start point SPT to a defined destination ZPT, wherein start point SPT and destination ZPT can be defined by a user input at the mobile communications terminal MG.

The transmitting device SV1-SV6 may comprise a number of transmitters, for example WLAN, Bluetooth, and/or Zigbee transmitters or a combination of transmitters (beacons or iBeacons). In some embodiments, for transmitting the position signals, the transmitting device SV1-SV6 is located in devices installed in building B or provided in building B. The use of existing infrastructure or infrastructure that is present in building B anyway saves installation costs. The transmitting device SV1-SV6 can for example be integrated in hazard alarms, in particular fire alarms, comfort control units, in particular room thermostats. Suitable radio transmitters (for example RFID transmitters) or other suitable NFC devices (NFC stands for Near Field Communication), for example BLE (Bluetooth Low Energy) can for example be used as transmitting device SV1-SV6.

The object P to be navigated can be a person who has an appropriately adapted communications terminal MG (for example smartphone) or be an appropriately adapted robot in the building (for example driverless transport system for delivering post or files, or a cleaning robot). The communications terminal MG can for example be provided with appropriate navigation software by a download.

The server S (for example Workstation, PC) and the storage unit SP (for example database server) may comprise a cloud infrastructure, with appropriate communications devices (for example Internet, radio, WLAN). In some embodiments, the communications link KV1 between the mobile communications terminal MG and the server S is a radio link.

The arrangement generates a navigation path NP, which is displayed for the person P on the mobile communications terminal MG. The navigation path NP leads from a start point SPT to a destination point ZPT. Start point SPT and destination point ZPT can be defined by the person P by appropriate inputs on the mobile communications terminal MG.

In some embodiments, the server S is adapted (for example by appropriate software programs), based on the respective received position signals PS1-PS6 and based on building data stored in the building information model BIM, to generate the navigation path NP for a respective object P from a defined start point SPT to a defined destination ZPT. Taking into account the building data stored in the building information model BIM ensures that the navigation path NP does not lead across an obstacle H located in building B but passes at a certain distance therefrom.

In some embodiments, the building data stored in the building information model BIM may include semantic information and/or metainformation (for example material, position, dimension of articles in the building). The building information model BIM can be defined for example based on IFC (Industry Foundation Classes). The building information model BIM can be stored for example in a relational database of the storage unit SP.

In some embodiments, the transmitting device SV1-SV6 may comprise an Indoor Positioning System (IPS). Indoor Positioning Systems (IPS) are common nowadays or can be easily retrofitted into a building B or on a campus.

In some embodiments, the server S may be integrated in a building control center, a building management system or in a central fire alarm system. By way of appropriate software, the server S can be easily rendered capable of calculating appropriate navigation paths.

In some embodiments, the mobile communications terminal MG may calibrate the position of the object P on the basis of the received position signals PS1-PS6. Individual transmitting devices SV1-SV6 can be adapted to transmit reference position signals for a calibration. The position of the object P can be calibrated such that the inaccuracy of the positioning is compensated from the received position signals PS1-PS6 such that the object P can only be located on a position graph or navigation graph NP. Positioning of an object P on an obstacle H is avoided thereby.

In some embodiments, a minimum spacing from the generated navigation path NP can be defined on the basis of the metadata of a stationary object (for example obstacle, table, shelf). This ensures that the navigation path NP has a minimum spacing from a stationary object. The metadata of the building objects advantageously includes a defined minimum spacing from the calculated navigation path.

In some embodiments, during an emergency evacuation, the navigation path NP can be calculated by the server S based on an escape route optimization and/or a pedestrian flow simulation.

In some embodiments, the mobile communications terminal MG may depict the calculated navigation path NP on the display of the mobile communications terminal MG. The mobile communications terminal MG may provide output acoustic signals to the navigation path NP.

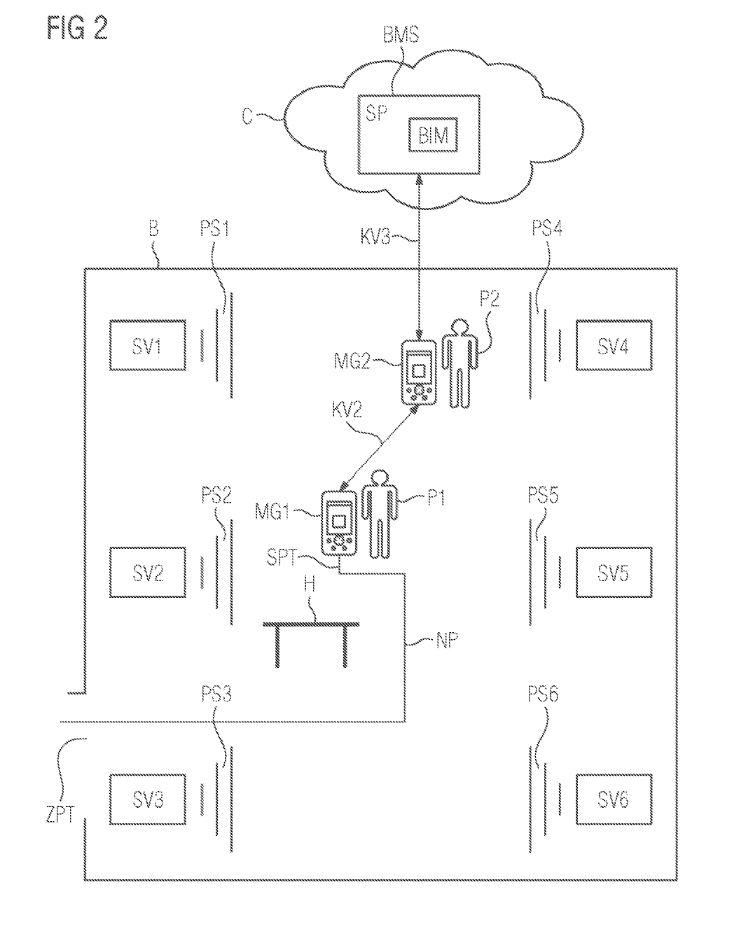

FIG. 2 shows a second exemplary arrangement for calculating navigation paths NP for objects P1 (for example people or mobile robots) in buildings B or on a campus. The second exemplary arrangement comprises: a transmitting device SV1-SV6 for transmitting position signals PS1-PS2; and a first mobile communications terminal MG1 (for example smartphone), associated with the object P1, adapted to receive the position signals PS1-PS2 and to transmit the position signals PS1-PS2 to a second mobile communications terminal MG2 (for example smartphone), the latter having a data link to a storage unit SP. A building information model BIM of the building B is stored in the storage unit SP. The second mobile communications terminal MG2 is adapted, based on the respective received position signals PS1-PS6 and based on building data stored in the building information model BIM, to generate a navigation path NP for a respective object P1 from a defined start point SPT to a defined destination point ZPT. The start point SPT and destination point ZPT can be defined by a user input at the first mobile communications terminal MG1.

In the arrangement of FIG. 2, the processing power for calculating the navigation path NP is provided by a network mobile communications devices MG2. The building information model BIM can optionally be decentrally distributed among the network of the mobile communications terminals MG2 or parts of the building information model BIM can be distributed by the storage unit SP among the network of the mobile communications terminals MG2.

In some embodiments, the transmitting device SV1-SV6 may comprise a number of transmitters, for example WLAN, Bluetooth, and/or Zigbee transmitters, or a combination of transmitters (beacons or iBeacons). In some embodiments, for transmitting the position signals, the transmitting device SV1-SV6 is located in devices (for example fire alarms) installed in building B or provided in building B. The use of existing infrastructure or infrastructure that is present anyway in building B saves installation costs. In some embodiments, the transmitting device SV1-SV6 can be integrated for example in hazard alarms, in particular fire alarms, comfort control units, in particular room thermostats. For example, suitable radio transmitters (for example RFID transmitters) or other suitable NFC devices (NFC stands for Near Field Communication) can be used, for example BLE (Bluetooth Low Energy), as transmitting device SV1-SV6.

In some embodiments, the object P1 to be navigated can be a person who has an appropriately adapted communications terminal MG1 (for example smartphone), or an appropriately adapted robot in the building (for example driverless transport system for delivering post or files, or a cleaning robot). The communications terminal MG1 can be provided with appropriate navigation software for example by a download.

In some embodiments, the storage unit SP (for example database server) may comprise a cloud infrastructure C, having appropriate communications devices (for example Internet, radio, WLAN). The communications link KV2 (between the mobile communications terminals MG1 and MG2) or the communications link KV3 (between the mobile communications terminal MG2 and the storage unit SP) is advantageously a radio link (for example WLAN).

The arrangement of FIG. 2 generates a navigation path NP, which is displayed on the mobile communications terminal MG1 of the person P1. The navigation path NP leads from a start point SPT to a destination point ZPT. Start point SPT and destination point ZPT can be defined by the person P1 by appropriate inputs on the mobile communications terminal MG1.

In some embodiments, the second mobile communications terminal or the second mobile communications terminals MG2 (in the case of a network of communications terminals MG2) is or are adapted (for example by appropriate software programs), based on the respective received position signals PS1-PS6 and based on building data stored in the building information model BIM, to generate the navigation path NP for a respective object P1 from a defined start point SPT to a defined destination ZPT. Taking into account the building data stored in the building information model BIM ensures that the navigation path NP does not lead across an obstacle H located in building B but passes at a certain distance therefrom.

In some embodiments, the building data stored in the building information model BIM may include semantic information and/or metainformation (for example material, position, dimension of articles in the building). The building information model BIM can be defined for example based on IFC (Industry Foundation Classes).

The building information model BIM can be stored for example in a relational database of the storage unit SP.

In some embodiments, the transmitting device SV1-SV6 may comprise an Indoor Positioning System (IPS). Indoor Positioning Systems (IPS) are common nowadays or can be easily retrofitted into a building B or on a campus.

In some embodiments, the storage unit SP (for example database server) may be integrated in a building control center, a building management system, or in a central fire alarm system. The storage unit SP may be connected to the second mobile communications terminal MG2 by appropriate software and communications mechanisms.

In some embodiments, mobile communications terminal MG1 may be adapted to calibrate the position of the object P1 on the basis of the received position signals PS1-PS6. Individual transmitting devices SV1-SV6 can be adapted to transmit reference position signals for a calibration.

In some embodiments, the position of the object P1 can be calibrated such that the inaccuracy of the positioning is compensated from the received position signals PS1-PS6 such that the object P1 can only be located on a position graph or navigation graph NP. Positioning of an object P1 on an obstacle H is avoided thereby. In some embodiments, a minimum spacing from the generated navigation path NP may be defined on the basis of the metadata of a stationary object (for example obstacle, table, shelf). This ensures that the navigation path NP has a minimum spacing from a stationary object. The metadata of the building objects may include a defined minimum spacing from the calculated navigation path NP.

In some embodiments, during an emergency evacuation, the navigation path NP can be calculated by the mobile communications terminal MG2 or by a network of mobile communications terminals MG2 based on an escape route optimization and/or a pedestrian flow simulation.

In some embodiments, the mobile communications terminal MG1 is adapted to depict the calculated navigation path NP on the display of the mobile communications terminal MG1. The mobile communications terminal MG1 may provide output acoustic signals to the navigation path NP.

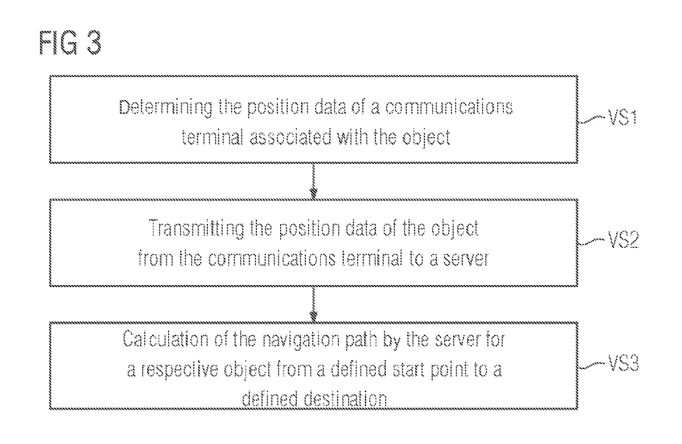

FIG. 3 shows an exemplary flowchart for calculating navigation paths for objects in buildings or on a campus, the method comprising: (VS1) determining the position data of a communications terminal associated with the object; (VS2) transmitting the position data of the object from the communications terminal to a server; and (VS3) calculation of the navigation path by the server for a respective object from a defined start point to a defined destination. The start point and destination can be defined by a user input at mobile communications terminal. The navigation path is calculated on the basis of the respective position data of the object and on the basis of building data stored in a building information model (BIM).

In some embodiments, the navigation path may be displayed on a mobile communications terminal (for example smartphone, tablet computer) associated with the object.

In some embodiments, the building data stored in the building information model (BIM) may include semantic information and/or metainformation (for example dimension, material, position data, orientation) for interior fittings and articles in the building.

In some embodiments, the position of the object may be calibrated such that the inaccuracy of the positioning is compensated from the received position signals such that the object can essentially or only be located on a position graph. As a result, the position of the object to be navigated on the building plan depicted on the display of the communications device is shown at a realistic location, for example on a passage and not on articles in the building.

In some embodiments, the method can be implemented by infrastructure which is in the building anyway. For example, positioning systems (for example IPS), mobile communications terminals (for example smartphone), server (for example workstation) with storage unit (for example database server) and building information model (BIM).

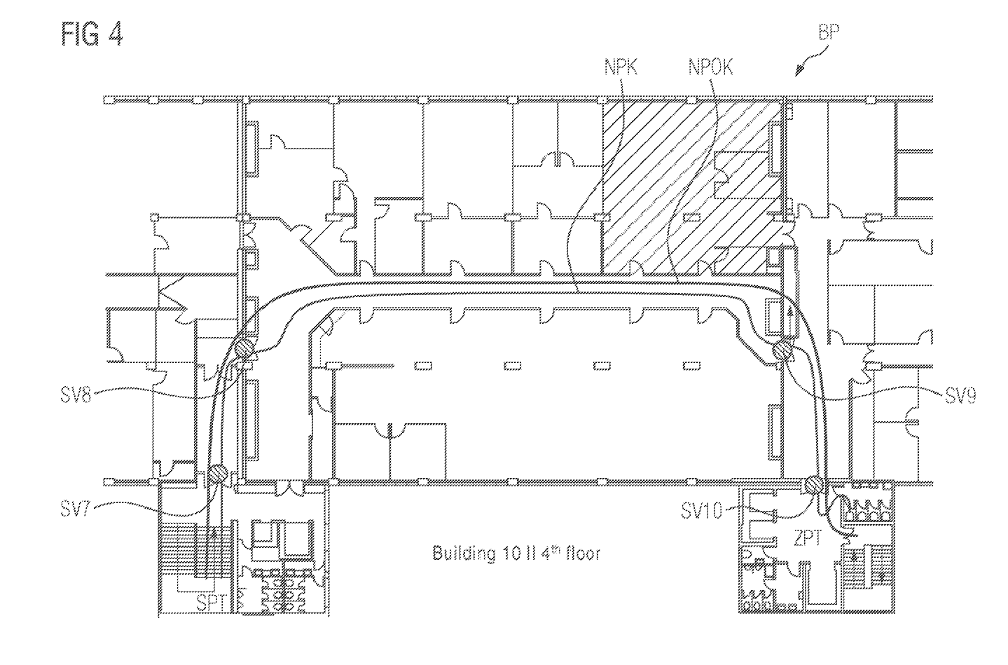

FIG. 4 shows an exemplary navigation path NPK, NPOK on an office layout BP in a building. The illustration of FIG. 4 shows an exemplary office layout BP (for notional building 10 II 4^{th} floor) having a number of rooms, doors, corridors, transmitters SV7-SV10, etc. The illustration of FIG. 4 also shows the start point SPT and the destination point ZPT for a navigation and the corresponding navigation graphs NPK, NPOK.

The navigation graph NPOK shows a depiction of the navigation graph without calibration. The navigation graph NPK shows a depiction of the navigation graph with calibration. In the depiction of the navigation graph NPK with calibration it is ensured that the navigation graph is always situated on accessible routes and does not lead, for example, through walls.

Reference numerals

| | |
|---|---|
| B | building |
| SV1-SV10 | transmitting device |
| PS1-PS6 | position data |
| S | server |
| SP | storage device |
| C | cloud |
| BIM | building information model |
| BMS | building management system |
| P, P1, P2 | object |
| MG, MG1, MG2 | mobile communications device |
| KV1-KV3 | communications link |
| NP, NPOK, NPK | navigation path |
| H | obstacle |
| SPT | start point |
| ZPT | destination point |
| VS1-VS3 | method step |
| BP | office layout |

1. An arrangement for calculating navigation paths for objects in a building and/or on a campus, the arrangement comprising:
a transmitter for transmitting position signals;
a mobile communications terminal associated with the object and receiving the position signals, configured to transmit the position signals to a server;
the server;
a storage unit associated with the server, storing a building information model of the building;
wherein the server receives the position signals transmitted by the mobile communications terminal; and
based on the respective received position signals and building data stored in the building information model (BIM), the server generates a navigation path for the object from a start point to a destination;
wherein the start point and the destination are defined by a user input at the mobile communications terminal.

2. An arrangement for calculating navigation paths for objects in a building and/or on a campus, the arrangement comprising:
a transmitter for transmitting position signals;
a first mobile communications terminal associated with a respective object receiving the position signals and configured to transmit the position signals to a second mobile communications terminal;
the second mobile communications terminal including a data link to a storage unit with a building information model of the building and/or campus stored therein;
wherein the second mobile communications terminal, based on the received position signals and building data stored in the building information model, generates a navigation path for the respective object from a start point to a destination;
wherein the start point and the destination depend on user input at the first mobile communications terminal.

3. The arrangement as claimed in claim 1, wherein the building data stored in the building information model includes semantic information and/or metainformation.

4. The arrangement as claimed in claim 1, wherein the transmitting device comprises an Indoor Positioning System.

5. The arrangement as claimed in claim 1, wherein the server is integrated in a building control center including a central fire alarm system.

6. The arrangement as claimed in claim 1, wherein the mobile communications terminal calibrates the position of the object based at least in part on the received position signals.

7. The arrangement as claimed in claim 6, wherein any inaccuracy in the position of the object is compensated from the received position signals, such that the object can be located on a position graph or navigation path.

8. The arrangement as claimed in claim 1, wherein a minimum spacing from the navigation path is defined on the basis of the metadata of a stationary object.

9. The arrangement as claimed in claim 1, wherein the metadata comprises a defined minimum spacing from the calculated navigation path.

10. The arrangement as claimed in claim 1, wherein during an emergency evacuation, the navigation path is calculated on the basis of an escape route optimization and/or a pedestrian flow simulation.

11. The arrangement as claimed in claim 1, wherein the mobile communications terminal depicts the calculated navigation path on a display of the mobile communications terminal.

12. The arrangement as claimed in claim 1, wherein the building data stored in the building information model includes metadata of mobile building objects, wherein the metadata defines a minimum spacing of mobile building objects from the objects on the navigation path.

13. A method for calculating a navigation path for an object in a building or on a campus, the method comprising:
determining position data corresponding to a communications terminal associated with the object);
transmitting the position data from the communications terminal to a server; and
calculating the navigation path with the server, the navigation path comprising a travel path for the object from a start point to a destination;
wherein the start point and the destination are defined by a user input at the communications terminal;
wherein calculating the navigation path depends at least in part on the basis of the respective position data of the object and on the basis of building data stored in a building information model.

14. The method as claimed in claim 13, further comprising displaying the navigation path on the communications terminal associated with the object.

15. The method as claimed in claim 13, wherein the building data stored in the building information model includes semantic information and/or metainformation.

16. The method as claimed in claim 13, further comprising calibrating the position of the object such that the inaccuracy of the positioning is compensated from the received position signals such that the object can be located on a position graph or navigation path.
